(19) United States
(12) Patent Application Publication
(10) Pub. No.: US 2012/0040174 A1
(43) Pub. Date: Feb. 16, 2012

(54) LOW DENSITY CORING MATERIAL

(76) Inventors: Robert Mark Adams, Cincinnati, OH (US); Randall Lake, Independence, KY (US); Louis Paul Schaefer, Trinity, FL (US); Helena Twardowska, Cincinnati, OH (US); Brian Kruchten, Royalton, MN (US)

(21) Appl. No.: 12/891,168

(22) Filed: Sep. 27, 2010

Related U.S. Application Data
(63) Continuation-in-part of application No. 12/853,382, filed on Aug. 10, 2010.

(51) Int. Cl. B32B 5/16; B05D 3/02; C08L 33/04

(52) U.S. Cl. 428/323; 524/502; 524/556; 427/379

(57) ABSTRACT

A low density coring material is described. In one embodiment, the low density coring material consists essentially of: about 40 to about 80 wt % resin, the resin consisting essentially of vinyl ester resin or a combination of vinyl ester resin and polyester resin; 0 to about 50 wt % monomer; 0 to about 5 wt % dispersion aid; 0 to about 5 wt % accelerator, or inhibitor, or both; about 3 to about 10 wt % microspheres; 0 to about 20 wt % fiber; 0 to about 20 wt % filler; and about 1 to about 5 wt % catalyst; wherein a density of the cured coring material is less than about 5.0 lbs/gal. Composites made using the low density coring material and methods of making composites are also described.

### STATEMENT OF RELATED CASES

This application is a continuation-in-part of U.S. application Ser. No. 12/853,382, filed Aug. 10, 2010, entitled Low Density Coring Material, which is incorporated herein by reference.

### FIELD OF THE INVENTION

This invention relates to a lightweight, polymer based coring material that can be used to replace higher density materials in composite manufacturing.

### BACKGROUND OF THE INVENTION

Composite materials such as fiberglass reinforced plastic (FRP) are used in a variety of applications, including marine, transportation, energy, and construction. As one illustrative example, an FRP composite 10 for a marine application has a structure as illustrated in FIG. 1. There is a gelcoat layer 15 followed by 1 layer with 1.0 oz. resin/glass 20. Next come 4 layers with 1.5 oz. resin/glass 25. They are followed by 1 layer with 1.0 oz. resin/glass 30 and a wood, foam, or honeycomb reinforcement layer 35. This composite contains about 8 oz. of resin/glass, which gives the composite good strength.

However, it would be desirable to reduce the weight of the composite for some applications. It would also be desirable to maintain the properties at the same level or to only have a slight reduction in properties.

Attempts have been made to utilize alternative materials in FRP composites. For example, lightweight materials such as balsa and CoreMat® have been tried. However, these materials require much more time to utilize. In addition, they are more expensive to use because of the very high resin demand. Furthermore, they cannot be used in all laminate structures due to the difficulty of hand laying them in small radius areas. Other low density materials do not provide sufficient weight reduction.

Therefore, there is a need for a material which allows the weight of a composite to be reduced.

### SUMMARY OF THE INVENTION

The present invention meets this need. One aspect of the invention is a low density coring material. In one embodiment, the low density coring material consists essentially of: about 40 to about 80 wt % resin, the resin consisting essentially of vinyl ester resin or a combination of vinyl ester resin and polyester resin; 0 to about 50 wt % monomer; 0 to about 5 wt % dispersion aid; 0 to about 5 wt % accelerator, or inhibitor, or both; about 3 to about 10 wt % microspheres; 0 to about 20 wt % fiber; 0 to about 20 wt % filler; and about 1 to about 5 wt % catalyst; wherein a density of the cured coring material is less than about 5.0 lbs/gal.

Another aspect of the invention is a composite. In one embodiment, the composite includes a first layer of resin/glass; a layer of low density coring material adjacent to the first layer of resin/glass, the coring material consisting essentially of: about 40 to about 80 wt % resin, the resin consisting essentially of vinyl ester resin or a combination of vinyl ester resin and polyester resin; 0 to about 50 wt % monomer; 0 to about 5 wt % dispersion aid; 0 to about 5 wt % accelerator, or inhibitor, or both; 0 to about 20 wt % fiber; 0 to about 20 wt % filler; about 3 to about 10 wt % microspheres; and about 1 to about 5 wt % catalyst; wherein a density of the cured coring material is less than about 5.0 lbs/gal; and a second layer of resin/glass or a bulk layer.

Another aspect of the invention is a method of making a composite. In one embodiment, the method includes depositing a first layer of resin/glass; curing the first layer; depositing a layer of low density coring material adjacent to the cured first layer, the coring material consisting essentially of: about 40 to about 80 wt % resin, the resin consisting essentially of vinyl ester resin or a combination of vinyl ester resin and polyester resin; 0 to about 50 wt % monomer; 0 to about 5 wt % dispersion aid; 0 to about 5 wt % accelerator, or inhibitor, or both; 0 to about 20 wt % fiber; 0 to about 20 wt % filler; about 3 to about 10 wt % microspheres; and about 1 to about 5 wt % catalyst; wherein a density of the cured coring material is less than about 5.0 lbs/gal; curing the layer of coring material; and depositing a second layer of resin/glass or a bulk layer adjacent to the cured layer of coring material.

### BRIEF DESCRIPTION OF THE DRAWINGS

FIG. 1 is an illustration of a prior art composite.

FIG. 2 is an illustration of one embodiment of a composite made according to the present invention.

FIG. 3 is a flow chart showing one embodiment of a method of making the low density coring material.

FIG. 4 is a flow chart showing one embodiment of a method of making a composite using the low density coring material.

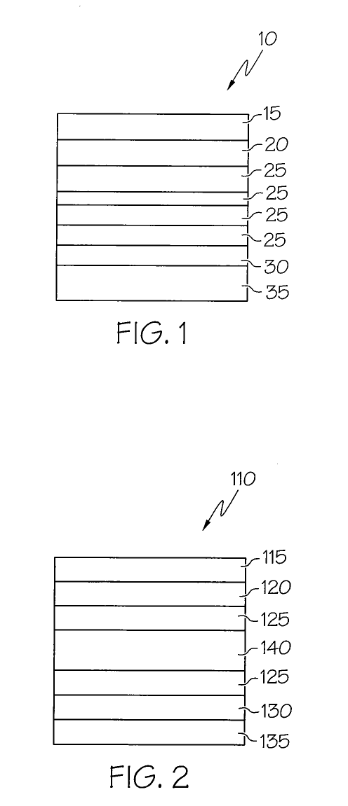

### DETAILED DESCRIPTION OF THE INVENTION

The present invention relates to a very lightweight, polymer based coring material that can be used to replace higher density materials used in composite manufacturing. A composite made using the low density coring material can have a density about 10 to about 50% lighter than fiber reinforced composite while retaining or improving the physical properties of normal composites. It allows reduced cycle time to manufacture the composite. It can also reduce the construction needed to produce open molding laminate structure. The low density coring material can be sprayed using available spray equipment, or it can be applied by hand.

The previous formulation (described in U.S. application Ser. No. 12/853,382, filed Aug. 10, 2010, entitled Low Density Coring Material), included about 40 to about 80 wt % of an unsaturated polyester resin. This formulation has demonstrated inconsistent results for cohesive adhesion. When the spray equipment was properly adjusted to provide even patterns of spray application and film cure profiles and the level of cure in the surrounding lamination layers was controlled to a tacky state, good results were obtained. However, deviation from the recommendations sometimes resulted in less than 100% glass/resin cohesive failure (typically 0 to about 80%). Although not wishing to be bound by theory, it is believed that the cohesive adhesion of the previous formulation is dependent on the state of cure of the surrounding lamination layers. In addition, if minimal tackiness was not achieved, “print through,” a common defect in which a glass fiber pattern appears in the final product, sometimes occurred. Thus, insufficient tack would result in print through, while too much cure (tack free or nearly tack free) would result in adhesion failure.

The present invention allows for a broader application window and a higher level of cure in the surrounding layers without the need for a mist coat, sanding, or bonding techniques, while providing good cohesive adhesion as evidenced by glass fiber tear (measured by ASTM D5573-99 (2005)—Standard Practice for Classifying Failure Modes in Fiber Reinforced Plastics (FRP) Joints). The present formulation does not depend on a tacky state of cure to achieve 100% glass/resin cohesive failure. It also reduces or eliminates print through. Application with the spray equipment can be more robust with varying application cure profiles and spray patterns while still providing excellent adhesion.

This is achieved by the inclusion in the formulation of an unsaturated vinyl ester resin which replaces some or all of the unsaturated polyester resin in the formulation. The total amount of resin (vinyl ester resin and unsaturated polyester resin) is generally in the range of about 40 to about 80 wt % of the composition, or about 60 to about 70 wt %. The resin can be 100 wt % vinyl ester in some applications. In other applications, a blend of vinyl ester resin and polyester resin can be used. In a blend, the ratio of vinyl ester resin to polyester resin can be from about 95:5 to about 5:95, or about 90:10 to 10:90, or about 80:20 to 20:80, or about 70:30 to 30:70, or about 60:40 to 40:60, or about 55:45 to 45:55, or about 50:50. In some applications, at least 50% of the resin should be vinyl ester resin.

The low density coring material has a very low cured density of less than about 5.0 lbs/gal, or about 2.8 to about 5.0 lbs/gal, or about 2.8 to about 4.5 lbs/gal, or about 2.8 to about 4.0 lbs/gal, or about 2.8 to about 3.5 lbs/gal. It provides high flexural strength, e.g., the flexural strength can be equal to or higher than a part made with standard polyester FRP. In some applications, it would be acceptable for the flexural strength to be slightly less than a part made with standard polyester FRP. It can improve productivity compared to traditional FRP. It provides high build; for example, there is no sag up to 750 mils in one pass.

FIG. 2 illustrates an example of a composite structure 110 made using the low density coring material. There is a gelcoat layer 115 and 1 layer with 1.0 oz. resin/glass 120 followed by 1 layer with 1.5 oz. resin/glass 125. This is followed by a layer of the low density sprayable material 140. This is followed by 1 layer with 1.5 oz. resin/glass 125 and 1 layer with 1.0 oz. resin/glass 130. The wood, foam, or honeycomb reinforcement layer 135 is last.

The low density coring material typically contains: about 40 to about 80 wt % resin, the resin consisting essentially of vinyl ester resin or a combination of vinyl ester resin and polyester resin, or about 65 to about 75 wt %, or about 68 wt %; 0 to about 50 wt % monomer, or about 20 to about 25 wt %, or about 24 wt %; 0 to about 5 wt % dispersion aid, or about 1.5 to about 3.0 wt %, or about 2.0 wt %; 0 to about 5 wt % accelerators and/or inhibitors, or about 0.05 to about 0.1 wt %, or about 0.08 wt %; about 3 to about 10 wt % microspheres; or about 3.0 to about 7.0 wt %, or about 4.0 wt %; 0 to about 20 wt % fiber, or about 0.5 to about 5 wt %, or about 1.2; 0 to about 20 wt % fillers, or about 0.5 to about 5 wt %, or about 1.2; and about 1 to about 5 wt % catalyst, or about 2.5 to about 3.5 wt %, or about 3.0 wt %.

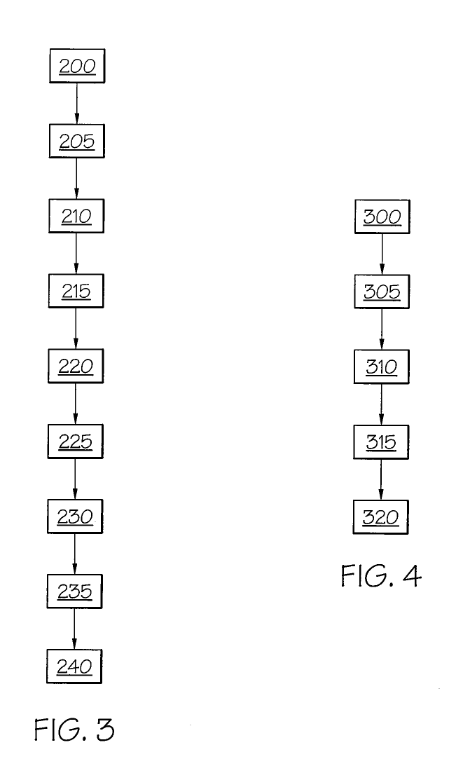

FIG. 3 illustrates a method of making the low density coring material. One or more resins are provided at block 200. The resin can be a vinyl ester resin, either alone or in combination with an unsaturated polyester resin. Suitable vinyl ester resins and unsaturated polyester resins can be obtained from Reichhold Chemical, for example.

The monomer (if used) is provided at block 205. The monomer is typically 0 to about 50 wt % of the composition. Suitable monomers include, but are not limited to, styrene monomers. If desired, the styrene content can be reduced by using low MW non-styrenated resins, such as those incorporating acrylates for example, as described in U.S. Publication No. 2007/0179250 and prepolymers formed by prereacting the acrylate resin to form a non-styrenated resin.

A dispersion aid (0-5 wt %) can be added at block 210.

The resin, monomer, and dispersion aid are mixed at block 215. The mixer can have a low shear helix blade and a high shear blade, if desired. The components mix readily. For example, suitable mixing can be obtained by initially mixing at low speed (e.g., about 20 rpm) with the helix blade, then at high speed (e.g., about 1100-1200 rpm) using the high shear blade.

One or more accelerators and/or inhibitors can be added at block 220. The accelerators and/or inhibitors can be used to control the cure profile by increasing or decreasing the gel time and/or to improve shelf life. Suitable accelerators include, but are not limited to, DMPT, DMA, DMAA, cobalt octoate, potassium octoate, copper napthanate and quaternary ammonium salts. Suitable inhibitors include HQ, MTBHQ, and NQ. The accelerators and/or inhibitors generally comprise 0 to about 5 wt % of the composition. The accelerators and/or inhibitors are mixed with the resin mixture for about 5 minutes with the helix blade at low speed (about 30 rpm) and with the high shear blade at high speed (1200-1300 rpm).

The high shear blade is turned off, the helix blade is put at a low speed (about 2-3 rpm), and the fibers and/or fillers are added at block 225. The fibers and/or fillers are added to provide strength.

The microspheres are added at block 230. The microspheres are included to reduce the density of the material. Glass, ceramic, or plastic microspheres can be used. When the low density coring material is to be applied by spraying, it is desirable to use plastic microspheres so that they do not break during the spraying process.

Plastic microspheres are typically present in an amount of about 3 to about 7 wt %. If the level is above about 7 wt %, it is difficult to obtain a homogeneous mixture. When the mixture is sprayed or applied by hand, the layer has clumps and is not smooth, which affects the integrity and strength of the layer. If the level is less than about 3 wt %, the weight is not reduced below about 5 lbs/gal, and there is no advantage to the material. Glass and ceramic microspheres are typically present in an amount of about 3 to about 10 wt %. The weight of the ceramic microspheres may make them less desirable in some applications.

The low density coring material is then mixed with the helix blade (e.g., about 20 rpm) and no shear for 30 min at block 235, and filtered through a mesh filter at block 240.

The low density coring material should have a gel time of about 25 to about 40 min (20.0 g. coring material with 0.50 g. MEKP 925 (1.2% vol/vol), mix for 60 sec). The viscosity should be about 7,000 to about 35,000 cps (RVT w/heliopath adapter, T-C @ 20 rpm measured with a Brookfield viscometer), or about 15,000 to about 19,000 cps. The thixotropic index should be about 3.0-4.5 cps (RVT w/heliopath adapter, T-C @ 2.5/20 rpm) The weight per gallon (WPG) should be less than about 5.0 lbs/gal, and the % non-volatiles should be about 55.0 to about 60.0.

A composite can be made using the method illustrated in FIG. 4. A layer of resin/glass is deposited at block 300. The layer of resin/glass can be sprayed on or applied by hand. The glass content of this layer of resin/glass should be about 30 to about 40%, or about 37%. If the glass content is lower than about 30%, the physical properties of the composite will be reduced, and the weight/ft² will increase and affect the weight per part savings. If the glass content is above about 40%, lower glass shear could result. The minimum final weight of the layer can be about 1.5 oz, although it could be higher if needed for strength. The lower the weight of the resin/glass layers, the lower the weight of the overall composite.

The catalyst for the resin/glass layer should be present in an amount of about 1% by volume. The catalyst % may vary depending on the temperature and cure of the resin used.

The surface of the first layer should be checked at block 305. It should be inspected for air voids, and any dry glass fibers, dust, and other particles should be removed.

The layer of low density coring material is applied at block 310. The viscosity of the low density coring material should be in the range of about 15,000 to about 19,000 cps, and the density should be less than about 5.0 lbs/gal. The gel time should be about 25 to about 40 min or about 25 to about 30 min for a 100 g mass. The typical layer thickness is more than about 60 mils.

The catalyst for the low density coring material is typically MEKP (methyl ethyl ketone peroxide) at a level of about 1.0 to about 5.0 wt %, or about 2.5 to about 3.5 wt %. The catalyst is added in the application equipment when spraying, and it is mixed in before application when being applied by hand.

The low density coring material can be sprayed or applied by hand if desired. When spray applied, the thickness of the layer of low density coring material should be checked after each pass. The typical (wet) thickness per pass is about 15 to about 40 mils. If the dry thickness of 80 to 96 mils is not reached after two passes, a third pass should be sprayed, and the thickness checked again. The spraying should be continued until the desired thickness is obtained.

The low density coring material should be cured to a tack free surface when the next layer is applied. It is desirably cured for at least about 25 min or more.

The surface of the low density coring material should be checked at block 315. Any rough spots or lumps should be removed to avoid second layer blisters, and any dust or other particles should be removed.

The bulk layer (the support material, e.g., wood, foam, or honeycomb) or a second (or more) resin/glass layer should then be applied at block 320. The bulk layer should generally be applied to the low density coring material after it has returned to ambient temperature and within 3 hrs of application. The characteristics of the additional resin/glass layer(s) could be similar to those for the first resin/glass layer or they could be different.

One of skill in the art will recognize that additional layers can be included before or after those described above. For example, there can be a gelcoat, and/or a barrier coat before the first resin/glass layer. There can be one or more resin/glass layers before the low density coring material, and one or more resin/glass layers after the low density coring material. There can be a bulk layer after one or more resin/glass layers or the bulk layer can directly follow the low density coring material.

### Example 1

Samples were made using the formulations shown in Table 1

The samples were made by preparing skin laminates manually, spraying core materials to the desired thickness (about 140 mils wet, 96 mils after cure), and applying bulk laminates manually. The skin laminate was allowed to cure for about 90 minutes (surface was not tacky). Core materials were allowed to cure for about 1 hr to get about 70% cure. The surface was slightly tacky at the time bulk layer was applied. General purpose laminating resin was used for making skin and bulk laminates.

TABLE 1

| | | | | 6 oz fiber glass |
|---|---|---|---|---|
| Composition | A | B | C | (33% with UPE) |
| Vinyl Ester 1 | 68 | | | |
| Unsaturated | | 68 | 69.2 | |
| Polyester 1 | | | | |
| Styrene | 24.6 | 24.6 | 24.6 | |
| Dispersant | 1.29 | 1.29 | 1.29 | |
| Inhibitors | 0.01 | 0.01 | 0.01 | |
| Accelerators | 0.6 | 0.6 | 0.6 | |
| Plastic microspheres | 4.3 | 4.3 | 4.3 | |
| Fibrous materials | 1.2 | 1.2 | | |

TABLE 2

| | | | | 6 oz fiber glass |
|---|---|---|---|---|
| Results | A | B | C | (33% with UPE) |
| Adhesion | | | | |
| Skin fiber tear (%) | 100 | 60-100 | 60-100 | 100 |
| Bulk fiber tear (%) | 100 | 50-100 | 50-100 | 100 |
| Mechanical | | | | |
| properties | | | | |
| Strength | 142 | 173 | 158 | 156 |
| Stiffness | 29 | 27 | 24 | 23 |
| Weight saving at | 30 | 28 | 28 | 100 |
| core thickness 90 | | | | |
| mils, % | | | | |

The results in Table 2 show that replacing all of the unsaturated polyester resin with vinyl ester resin in one coring formulation improves adhesion and gives 100% cohesive failure. The coring compositions with vinyl ester are more robust than those with unsaturated polyester resins. The mechanical properties are acceptable with all coring formulations and the weight savings are in the range of 25 to 30%. The addition of fibrous material such as wollastonite (Nyad G) results in increased mechanical properties, especially modulus (samples A and B). Other additives, such as milled fiber glass and milled carbon fiber, may improve mechanical properties more significantly. Likewise additives such as micas and pigments can be used to add additional strength.

The use of unsaturated polyester resin combined with vinyl ester resin could be acceptable for some applications.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A low density coring material consisting essentially of:
about 40 to about 80 wt % resin, the resin consisting essentially of vinyl ester resin or a combination of vinyl ester resin and polyester resin;
0 to about 50 wt % monomer;
0 to about 5 wt % dispersion aid;
0 to about 5 wt % accelerator, or inhibitor, or both;
about 3 to about 10 wt % microspheres;
0 to about 20 wt % fiber;
0 to about 20 wt % filler; and
about 1 to about 5 wt % catalyst;
wherein a density of the cured coring material is less than about 5.0 lbs/gal.

2. The coring material of claim 1 wherein the density of the cured coring material is in a range of about 2.8 to about 4.0 lbs/gal.

3. The coring material of claim 1 wherein a gel time of the coring material is in a range of about 25 to about 40 min.

4. The coring material of claim 1 wherein a viscosity of the uncured coring material is in a range of about 7,000 to about 35,000 cps.

5. The coring material of claim 1 wherein there is about 65 to about 75 wt % vinyl ester resin; about 20 to about 25 wt % monomer; 0 to about 5 wt % dispersion aid; 0 to about 5 wt % accelerator, or inhibitor, or both; about 3 to about 10 wt % microspheres; 0 to about 20 wt % fiber, 0 to about 20 wt % filler; and about 1 to about 5 wt % catalyst,

6. The coring material of claim 1 wherein the monomer is a styrene monomer.

7. A composite comprising:
a first layer of resin/glass;
a layer of low density coring material adjacent to the first layer of resin/glass, the coring material consisting essentially of:
about 40 to about 80 wt % resin, the resin consisting essentially of vinyl ester resin or a combination of vinyl ester resin and polyester resin;
0 to about 50 wt % monomer;
0 to about 5 wt % dispersion aid;
0 to about 5 wt % accelerator, or inhibitor, or both;
about 3 to about 7 wt % microspheres;
0 to about 20 wt % fiber;
0 to about 20 wt % filler; and
about 1 to about 5 wt % catalyst;
wherein a density of the cured coring material is less than about 5.0 lbs/gal; and
a second layer of resin/glass or a bulk layer.

8. The composite of claim 7 wherein the density of the layer of cured coring material is in a range of about 2.8 to about 4.0 lbs/gal.

9. The composite of claim 7 wherein a thickness of the layer of coring material is at least about 80 mils.

10. The composite of claim 7 wherein the first layer has about 30 to about 40 wt % glass.

11. The composite of claim 7 wherein there is about 65 to about 75 wt % vinyl ester resin; about 20 to about 25 wt % monomer; 0 to about 5 wt % dispersion aid; 0 to about 5 wt % accelerator, or inhibitor, or both; about 3 to about 10 wt % microspheres; 0 to about 20 wt % fiber; 0 to about 20 wt % filler; and about 1 to about 5 wt % catalyst;

12. A method of making a composite comprising:
depositing a first layer of resin/glass;
curing the first layer;
depositing a layer of low density coring material adjacent to the cured first layer, the coring material consisting essentially of:
about 40 to about 80 wt % resin, the resin consisting essentially of vinyl ester resin or a combination of vinyl ester resin and polyester resin;
0 to about 50 wt % monomer;
0 to about 5 wt % dispersion aid;
0 to about 5 wt % accelerator, or inhibitor, or both;
about 3 to about 10 wt % microspheres;
0 to about 20 wt % fiber;
0 to about 20 wt % filler; and
about 1 to about 5 wt % catalyst;
wherein a density of the cured coring material is less than about 5.0 lbs/gal;
curing the layer of coring material; and
depositing a second layer of resin/glass or a bulk layer adjacent to the cured layer of coring material.

13. The method of claim 12 wherein the first layer has about 30 to about 40 wt % glass

14. The method of claim 12 wherein a thickness of the layer of coring material is at least about 80 mils.

15. The method of claim 12 wherein the layer of coring material is deposited by spraying.

16. The method of claim 15 wherein the microspheres are plastic microspheres.

17. The method of claim 12 wherein the layer of coring material is deposited by hand.

18. The method of claim 12 wherein there is about 65 to about 75 wt % vinyl ester resin; about 20 to about 25 wt % monomer; 0 to about 5.0 wt % dispersion aid; 0 to about 5 wt % accelerator; about 3 to about 10 wt % microspheres; 0 to about 20 wt % fiber; 0 to about 20 wt % filler; and about 1 to about 5 wt % catalyst;

19. The method of claim 12 wherein the coring material is cured to a tack free surface.

20. The method of claim 12 wherein the coring material is cured for at least about 25 min.
